(19) United States
(12) Patent Application Publication
(10) Pub. No.: US 2010/0093381 A1
(43) Pub. Date: Apr. 15, 2010

(54) MESSAGING METHOD AND APPARATUS

(75) Inventor: Michael Andrew Maguire, London (GB)

Correspondence Address: MCKEE, VOORHEES & SEASE, P.L.C., 801 GRAND AVENUE, SUITE 3200, DES MOINES, IA, 50309-2721, US

(73) Assignee: BLUE WHALE SYSTEMS LIMITED, LONDON (GB)

(21) Appl. No.: 12/530,800

(22) PCT Filed: Mar. 12, 2008
(86) PCT No.: PCT/GB2008/000864

§ 371 Date: Oct. 6, 2009

(30) Foreign Application Priority Data
Sep. 10, 2009 (GB) GB0704836.6

(51) Int. Cl. H04W 4/12

(52) U.S. Cl. 455/466

(57) ABSTRACT

The present invention relates to the field of mobile communications and in particular to messaging methods and systems using mobile communications terminals. The invention provides for the ability for a message to be transmitted to a recipient device in a number of different formats dependent upon the information which is known about the recipient device at that time. Said information may include a messaging address and/or telephony identifier and the possible message formats include e-mails and SMS formats. The particular format selected and the particular device information used to send the message can be selected to suit particular conditions and requirements thereby providing a method and system for ensuring that transmitted messages are received most efficiently.

### FIELD OF THE INVENTION

The present invention relates to the field of mobile communications and in particular to messaging methods and systems using mobile communications terminals.

### BACKGROUND OF THE INVENTION

In recent years, the popularity of and demand for mobile messaging services have increased. In particular, the use of Short Messaging Service (SMS) messaging with telephony terminals in communications systems has become widespread. SMS messaging is a service that enables short messages to be sent between messaging devices using a telephone number; it is particularly popular for sending messages between mobile telephones, but can also be used for sending messages to and from, for example, personal computers or some landline telephones. SMS is available for use in various cellular radio networks, such as GSM, UMTS, CDMA and TDMA networks. SMS messaging uses a store and forward mechanism in which messages are initially sent to a message centre which attempts to forward the message to the recipient device. If the message cannot be sent, it is typically queued for later retry.

Another type of messaging service is email (electronic mail) messaging. Email can be used to send messages between electronic messaging devices such as personal computers and mobile telephones via the internet or an intranet system. Each messaging device typically has an associated server and an inbox at the server with a specified email address for receiving messages. Messages are transferred between messaging devices and email messaging servers using protocols such as Post Office Protocol (POP3), Internet Message Access Protocol (IMAP) or Simple Mail Transfer Protocol (SMTP), and transferred between servers using SMTP. A message sent from a first device contains one or more destination addresses for the message, and the message is routed to the inbox or inboxes specified by the address or addresses. The message then remains in the inbox until the corresponding mobile terminal accesses the inbox and retrieves the message. The format of e-mail messages is defined in RFC 2822 and RFC 2045 to RFC 2049.

An advantage of SMS messaging over other messaging technologies such as email and instant messaging, etc. is that an SMS message can be sent using the telephone number of the recipient, without the need for extra information, such as an additional recipient address. The amount of information that users are required to input and store on their telephony terminals is therefore less than that required for other messaging technologies.

Another advantage of SMS is that the message typically arrives at its destination very soon after it is sent; although latencies in SMS systems can sometimes impose delays of 24 hours or longer, messages typically arrive a few seconds or minutes after sending, and there is an expectation amongst users that messages will arrive almost immediately after sending.

However, a disadvantage of SMS is that SMS messages typically incur a cost per message for the sender, which is not the case with other messaging technologies.

Some existing systems use a proprietary instant messaging protocol for communication between the client and a server, the latter storing messages and routing them between two users. However, this has the disadvantage that the provider of the service must implement and maintain the messaging server infrastructure which supports all of its users.

Other systems use SMS as a notification mechanism to inform users when a new email message has arrived at their inbox. The user then typically logs on to their email account to retrieve the message or a messaging application does this automatically. However, the sender needs to know the recipient's email address and this system also has the disadvantage that the SMS notification message is necessarily sent at the expense of the recipient of the message; while a sender will often be willing to pay to ensure that his (potentially urgent) message arrives promptly, recipients are often unwilling to pay to be informed of the arrival of a message of whose contents and urgency they are unaware.

U.S. Pat. No. 7,171,190 relates to a method of sending messages between different types of messaging devices. In the system described, a message may be sent using, for example, SMS or Fax, but then converted into and delivered as, for example, an email or Instant Messaging message. Messages can be sent using only the identifier or address appropriate for the format used for sending; the identifier or address for the format of delivery does not necessarily have to be specified. The system uses a database containing addresses and identifiers of users. However, this system does not provide a method in which the user of the telephony terminal from which the message is sent may select an address or identifier of the destination telephony terminal conventional for a format other than that used for the message at the point of sending. For example, it does not provide a method of sending an email using a telephony identifier as a destination address for the message. Furthermore, messages cannot be sent to recipients not listed in the database.

UK Patent Application GB 2381998 A describes a system in which email messages are converted into SMS messages and delivered to the recipient's mobile telephone. Where the email message is too large to fit into the maximum 160 characters, a part of the email is sent as an SMS message; the recipient may then request more of the message to be sent by subsequent text messages. This nonetheless requires the sender to manually input and store the email address of the recipient in his mobile telephone. Furthermore, the expense of sending an SMS message is incurred every time this service is used.

It is an object of the present invention to provide methods of, and apparatus for, transmitting and/or receiving messages that mitigate at least some of the problems of the prior art.

### SUMMARY OF THE INVENTION

In accordance with one aspect of the present invention, there is provided a method of messaging in a data communications network using a messaging application stored on a telephony terminal, said method comprising the steps of:

receiving a message using said messaging application, said received message comprising data indicating a telephony identifier of the sender of the message and further comprising data indicating a messaging address of the sender, said messaging address being different to said telephony identifier;

using the data indicating a telephony identifier to identify an entry of a contacts directory of said telephony terminal;

creating an association between said messaging address and said telephony identifier; and
transmitting a message using said messaging application, said transmitted message including said messaging address as a destination address.

Typically the transmission includes said messaging address as a destination address in response to a user selection of said entry of the contacts directory.

Thus, the present invention provides a method in which the messaging address of the sender of a message is cached on receipt of the message, allowing this address to be used for sending responses or other messages to the sender of the original message. This enables a single messaging application to receive a message which identifies the sender of a message by a corresponding telephony identifier, and then uses a different messaging address to send subsequent messages to that sender. This avoids the requirement for manual entry and storage of messaging addresses that is concomitant to prior art systems.

In some embodiments, said messaging address is not held in said contacts directory before the received message is received. Embodiments of the present invention allow messages to be sent using the messaging address even where the messaging address is not initially known, but where the telephony identifier is known.

Alternatively, or additionally, said creating is done without any user input. Thus, the contacts directory is updated in response to receipt of the information without any need for the user to provide any manual input, minimising inconvenience to the user.

In some preferred embodiments, the received message is sent from the sender via a server, and an originating address of the received message is inserted by the server. The inserted originating address may comprise an address of the server. In some other preferred embodiments, the inserted originating address of the received message is inserted by the sender. The inserted originating address may then comprise an address of the sender. Embodiments of the present invention may thus be implemented both where the sender address of the message received at the telephony terminal is that corresponding to the sender of the message, and where the sender address is that of an intermediate server, allowing for various different sending methods to be used by the sender of the message.

Alternatively, or additionally, user selection of said entry comprises entry or selection of said telephony identifier by the user. Thus, the present invention allows messages to be sent to messaging addresses by means of a corresponding telephony identifier.

In preferred embodiments, said messaging address comprises an email address and said message comprises an email. The received message may comprise an email. The present invention allows entries in contacts directories to be updated with email addresses and the email address subsequently to be used as the address for emails upon selection of the entry.

In accordance with a second aspect of the present invention, there is provided a method of transmitting messages, originated from a first telephony terminal, via a data communications network, said network comprising a server, said server comprising a database of telephony identifiers of telephony terminals and email addresses, each email address being associated with a corresponding telephony identifier, said method comprising:

transmitting a first message to a second telephony terminal, wherein transmitting said first message comprises:

selecting a telephony identifier of the second telephony terminal;
determining whether said telephony identifier of the second telephony terminal is listed in said database; and
in response to determining that said telephony identifier of the second telephony terminal is listed in said database, using said database and said telephony identifier of the second telephony terminal to determine an associated email address, and sending said first message to said associated email address,
said method further comprising transmitting a second message to a third telephony terminal, wherein transmitting said second message comprises:

selecting a telephony identifier of the third telephony terminal;

determining whether said telephony identifier of the third telephony terminal is listed in said database; and

in response to determining that said telephony identifier of the third telephony terminal is not listed in said database, addressing said second message using said telephony identifier of said third telephony terminal, and sending said second message.

This aspect of the invention allows emails to be sent between users of telephony terminals without knowing the email address of the recipient of the email. Email messages can instead be sent by means of a telephony identifier of the recipient. Furthermore, messages can be communicated to recipients who are not listed in the database.

In some embodiments said sending said first message comprises sending from said server. In some embodiments, sending said second message comprises sending from said server. The method may comprise receiving a message from said first telephony terminal at said server. The received message may be addressed to an email address of the server and received via email. In some embodiments, the received message does not include said associated email address. These features allow for messages to be sent by email, via a server, without the sender knowing the email address of the recipient.

In some embodiments, the message sent to the third mobile communications terminal comprises an SMS message. This provides a method of sending messages to recipients not listed in the server database. Where this involves sending an SMS message, while costs concomitant to SMS are incurred, since the SMS message is sent from a server, costs will typically be lower than those involved with sending an SMS directly from one terminal to another.

In accordance with a third aspect of the present invention, there is provided a method of transmitting a first message in a data communications network, the message having as an originating point a first user terminal and having as a destination point a second user terminal, at least the second user terminal being a mobile communications terminal capable of receiving service in a mobile communications network, and at least the second user terminal being capable of receiving messages using a first messaging protocol and messages using a second messaging protocol, said method comprising:

sending said first message using a first messaging protocol;

monitoring for an acknowledgement of receipt of said message; and

in response to determining that no said acknowledgement is received, causing a second message to be sent using a second messaging protocol.

This provides a convenient method for ensuring delivery of the message. Messaging protocols allow for receipt acknowledgements to be sent on receipt of a message. The present invention uses this feature as a convenient way of monitoring for delivery of a message. Where no acknowledgement of the delivery of the message is received, a fallback message is sent using a second protocol; this improves the reliability of message delivery. Furthermore, the method allows for usage of fallback messaging to be monitored, and charges for the service to be charged to the sender, rather than the recipient, of messages.

In some embodiments, said data communications network comprises a server, said server causing said second message to be sent. Said monitoring may be conducted at said server. It may be convenient for the server to be used for monitoring for acknowledgements and sending fallback messages in order to conserve the resources of the user terminal, such as battery power.

In other embodiments, said monitoring is conducted at said first communications terminal and said causing comprises sending a third message from said first user terminal to said server. In some arrangements, it may be convenient to conduct the monitoring at the user terminal in order to reduce the burden on the server. In preferred embodiments, said third message is sent using said first messaging protocol. It may be undesirable or inefficient to convert the message into a form suitable for sending using the second messaging protocol at the first user terminal.

Alternatively, or additionally, said first messaging protocol is suitable for transmitting emails and said first message comprises an email message. The acknowledgement being monitored may comprise an email. In some embodiments said second messaging protocol is suitable for transmitting SMS messages and said second message comprises an SMS message. Thus, a method is provided for transmitting email messages which uses receipt acknowledgements in combination with SMS messaging to improve reliability of message delivery.

In some arrangements, said third message is sent using said first messaging protocol. This means that the user terminal device only needs to send messages using one messaging protocol.

In some embodiments, said server comprises a database of telephone numbers of mobile communications terminals and email addresses, each email address corresponding to a telephone number, and said third message comprises information indicating an email address corresponding to a telephone number of said second communications terminal. Said database and said email address may be used to determine said telephone number of said second communications terminal and said second message sent to said telephone number of said second communications terminal. This provides a convenient way of routing the fallback message. If no receipt acknowledgement is received for an email message, another email is sent to the server which causes a fallback SMS message to be sent to a mobile communications terminal of the recipient; this may be done even where the sender does not know the mobile telephone number of the recipient. In some arrangements, said causing comprises causing said second message to be sent from an SMS bulk server. This provides a convenient method of sending the fallback SMS message.

Alternatively, or additionally, said second message comprises at least part of said first message. Where, for example, the email message is short enough that its contents may be sent in a single SMS message, it is convenient and efficient that the fallback SMS message provides the recipient with said contents, so that the user does not have to take any further action in order to discover the contents of the message. This may be particularly useful where the message is urgent.

Said second message may comprise a command to start up a messaging application. Some embodiments further comprise starting up said messaging application and using said messaging application to retrieve said first message in response to receiving said command. This allows the original message to be retrieved promptly, without having to wait for the next occasion on which the messaging application otherwise retrieves messages.

In preferred embodiments, said monitoring comprises monitoring for the elapsing of a predetermined time interval and the causing of the sending of the second message is done in response to said elapsing. It may be advantageous for there to be a maximum time limit for receiving acknowledgement of delivery of the message, after which a fallback message is sent, in effect setting a maximum delivery time for the message.

In some preferred embodiments, the length of said predetermined time interval is determined by a parameter of the first message. This parameter may be, for example, a level of urgency of the message, so that fallback messages are sent more quickly for more urgent messages than for less urgent messages. Said parameter may be capable of being varied by a user. The user may desire to choose to set a low time limit for urgent messages, to ensure timely delivery, and a high time limit for non-urgent messages, so as not to incur the potential extra expense of sending a fallback message unnecessarily.

In accordance with a fourth aspect of the present invention, there is provided apparatus arranged to implement the method steps described above in relation to any of the first, second and third aspects of the invention.

In accordance with a fifth aspect of the present invention, there is provided a telephony terminal adapted to perform the method steps described above in relation to a first aspect of the present invention.

In accordance with a sixth aspect of the present invention, there is provided a computer program arranged to adapt a telephony terminal to perform the method steps described above in relation to a first aspect of the present invention.

In accordance with a seventh aspect of the present invention, there is provided a telephony terminal adapted to perform the method steps described above in relation to a second aspect of the present invention.

In accordance with an eighth aspect of the present invention, there is provided a computer program arranged to adapt a telephony terminal to perform the method steps described above in relation to a second aspect of the present invention.

In accordance with a ninth aspect of the present invention, there is provided a server adapted to perform the method steps described above in relation to a third aspect of the present invention.

In accordance with a tenth aspect of the present invention, there is provided a computer program arranged to adapt a server to perform the method steps described above in relation to a third aspect of the present invention.

In accordance with a yet further aspect of the invention there is provided a method of messaging using a data communications network including a plurality of user controlled message transmitting and receiving devices, said network including a server used to control the transmission of said messages in differing formats, said network also including a database on which are stored identifiers, each identifier relating to a specific transmitting and receiving device, and a messaging address of the message sender and upon receipt of a message from a specific device which includes an identifier and a messaging address, an association between the same is established and wherein thereafter a message can be sent to the specific device using the identifier and/or messaging address, and the format in which the message is sent is dependent upon whether the identifier or messaging address is used and/or other information associated therewith.

In one embodiment the message is transmitted in a first format and, if not received successfully is resent in a second format.

In one embodiment the message is transmitted in a first format using the messaging address and in a second format using the identifier which is a telephony identifier.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a plurality of telephony terminals, a network and connections between them;

FIG. 2 shows one of the telephony terminals downloading a messaging application from a messaging application provider via the network;

FIG. 3 shows a plurality of the telephony terminals, and components of the network including a plurality of ISP email servers, a messaging gateway server containing a database, an SMS server and connections between them;

FIG. 4 is a flow diagram showing the operation of the messaging application in sending email messages;

FIG. 5 shows a contacts directory of a telephony terminal;

FIG. 6a shows a first email structured for sending to a messaging gateway server;

FIG. 6b shows a second email structured for sending to a messaging gateway server;

FIG. 6c shows an email structured for sending from a gateway server to a recipient;

FIG. 6d shows an email structured for sending from a sender terminal to a recipient terminal;

FIG. 7 is a flow diagram showing the operation of a messaging gateway server in receiving, analysing and sending messages;

FIG. 8 shows a messaging server database;

FIG. 9 is a flow diagram showing the operation of a messaging application in performing directory updating;

FIG. 10a shows a contacts directory prior to a directory updating operation;

FIG. 10b shows a contacts directory after performance of a directory updating operation;

FIG. 11a shows an email structured for sending from a sending terminal to a recipient terminal;

FIG. 11b shows a receipt acknowledgement;

FIG. 11c shows an email structured for sending from a telephony terminal to a messaging gateway server;

FIG. 12 is a flow diagram showing the operation of a messaging client in implementing fallback messaging;

FIG. 13 is a flow diagram showing the operation of a messaging gateway server in implementing fallback messaging; and

FIG. 14 shows components of a system interacting in implementing fallback messaging.

### DETAILED DESCRIPTION OF THE INVENTION

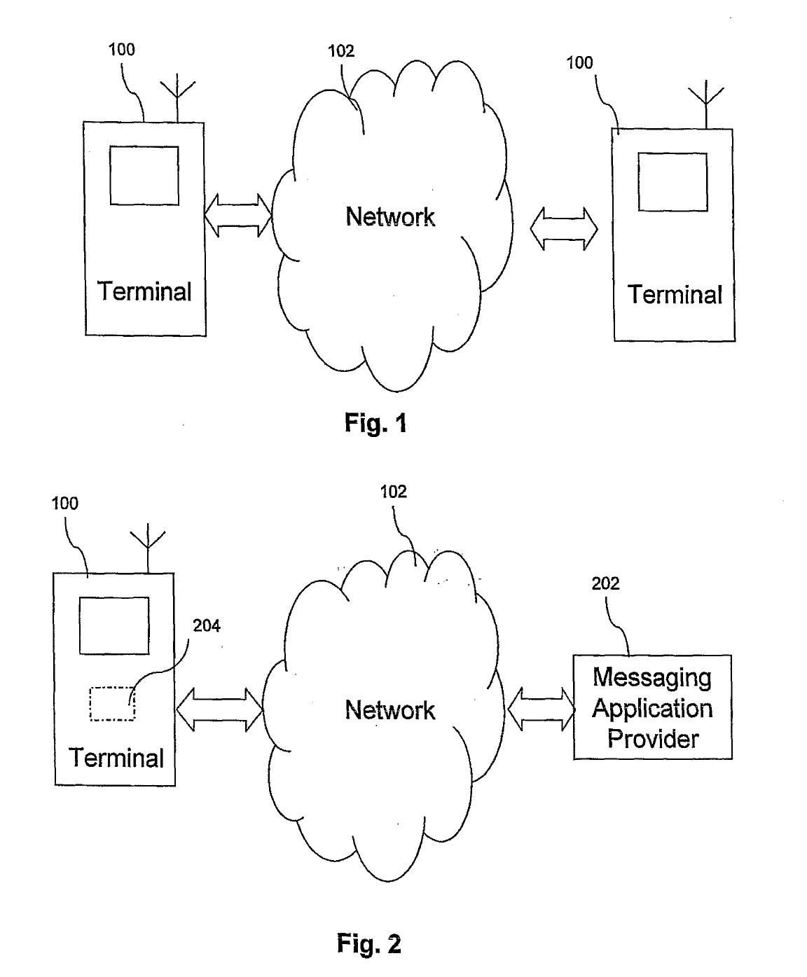

Embodiments of the present invention relate to methods of messaging in communications networks. FIG. 1 is a representation of a system in which embodiments of the present invention may be realised. Messages are sent between telephony terminals 100 via a network 102. Typically, communication is possible between many different telephony terminals, but only two are represented here for conciseness. The way in which messages are communicated between telephony terminals varies according to the type of messaging used.

The network 102 is shown as a single network, however, it should be understood that the network 102 may include a number of different interconnected networks, including one or more radio access networks such as a cellular radio network, for example a GSM or 3GPP network. Communication between the telephony terminals and the network is typically implemented using radio signals and using a connection-based packet mode protocol, such as TCP. Telephony terminals may be user terminals such as mobile communications devices such as mobile telephones, or other user terminals such as personal computers.

Some types of telephony terminals, commonly referred to as “smartphones” are capable of installing and running messaging applications which may be added by the user. FIG. 2 illustrates a messaging application 204 being downloaded for use on a terminal 100 from a messaging application provider 202, via the network 102. Embodiments of the present invention use such a messaging application which a user may initially download and install on their telephony terminal 100, though other means for installing and running the application are envisaged. In some cases, telephony terminals may be pre-installed with the messaging application prior to purchase.

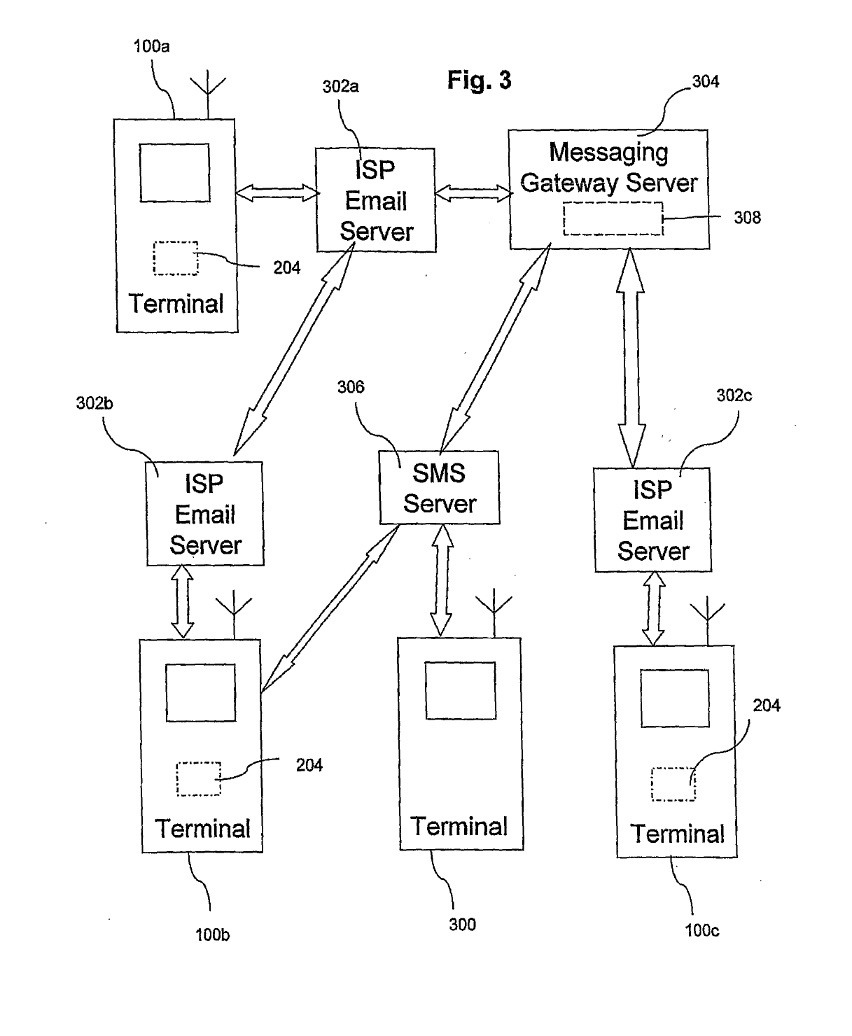

FIG. 3 shows a more detailed representation of a system in which embodiments of the present invention may be implemented. Messages can be sent between telephony terminals 100a, 100b, 100c and 300 via ISP (Internet Service Provider) email servers 302a . . . 302c, a messaging gateway server 304 and an SMS server 306. Telephony terminals 100a, 100b and 100c are installed with messaging application 204, and are each capable of receiving email, each telephony terminal having access to an email inbox at ISP email servers 302a, 302b and 302c respectively. Terminal 300 is not installed with messaging application 204. Messaging gateway server 304 comprises a database 308 comprising a list of telephone numbers and associated email addresses of subscribers of a service. In the present example, there are listings in the database corresponding to terminals 100a, 100b and 100c, but no listing for terminal 300.

The components shown in FIG. 3 form part of a network as described in relation to FIG. 1 above; the network will typically comprise many other components that have been omitted from FIG. 3 for conciseness. Communication between the components shown may be implemented using an application layer internet protocol such as POP3, IMAP or SMTP. The arrows represent routes of communication in the system; not all possible routes are represented.

We consider three cases of sending messages from sending terminal 100a.

### Case 1: Sending a Message Using a Recipient Email Address

In the first case, we consider an email being sent from a sending terminal 100a to a first recipient terminal 100b using an email address associated with the recipient terminal 100b. The message may be composed using messaging application 204, and an email address corresponding to the recipient terminal 100b selected as the destination address for the message. The message is then routed via ISP email servers 302a and 302b. Typically, the message will arrive at and be stored in an inbox of ISP email server 302b and subsequently be downloaded to recipient terminal 100b.

### Case 2: Sending a Message Using a Recipient Telephone Number—Case I

Embodiments of the present invention also provide a method of sending messages without knowing an email address of the recipient terminal, instead using a telephony identifier, such as a telephone number, of the terminal receiving the message. An example is now described with reference to FIG. 3 in which a message is sent from the sending terminal 100a to a second recipient terminal 100c. The user of 100a may not initially have access to an email address associated with terminal 100c, or, even if the email address is available, it may be inconvenient to use it. In this case, the message is created using the messaging application 204, and sent by selecting a telephone number of the recipient terminal 100c; no email address of the recipient terminal 100c is selected for sending the message.

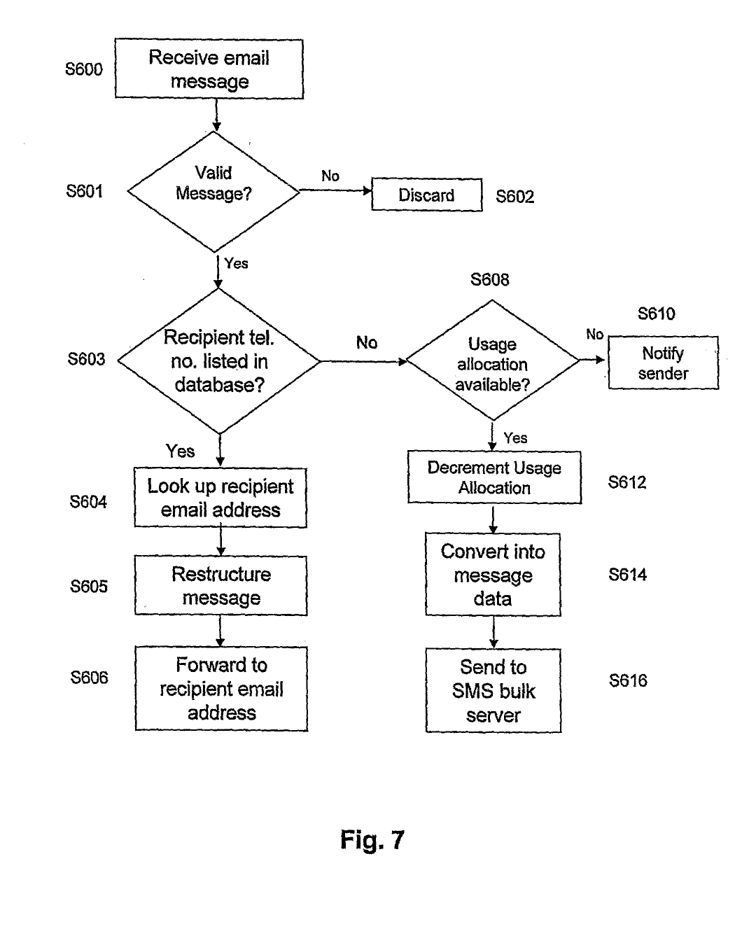

Since no email address for the recipient terminal 100c is selected, the message cannot be routed in the same way as the email described in case 1 above. Instead, the messaging application 204 of the sending terminal 100a sends the message to the messaging gateway server 304, using an email address of the messaging gateway server 304. The email sent to server 304 contains information indicating the aforementioned telephone number of recipient terminal 100c. The messaging gateway server 304 determines whether the telephone number is listed in the database 308; having determined that the telephone number is listed, the messaging gateway server 304 uses the telephone number to determine an email address of terminal 100c and send an email message to an inbox of an ISP email server 302c, from which terminal 100c may download the message. Functions of the messaging gateway server 304 will be described in detail below with reference to FIG. 7 and FIG. 8.

In other arrangements, having determined the email address of recipient terminal 100c, the messaging gateway server 304 sends an email containing the email address of the recipient terminal 100c to the sending terminal 100a; the messaging application 204 of the sending terminal 100a may then use the latter email address to address and send a message to the recipient terminal 100c.

Thus, in these arrangements, email messages can be sent between terminals by selecting a telephone number of the recipient terminal 100c, and without knowing an email address of the recipient terminal.

### Case 3: Sending A Message Using a Recipient Telephone Number—Case II

We now turn to consider, with reference to FIG. 3, a third case of sending a message, in which a message is sent from the sending terminal 100a to a third recipient terminal 300. In this case, no email address of the recipient terminal 300 is used, and, further, no email address of the recipient terminal 300 is listed in the database of the messaging gateway server 304. As mentioned above, the recipient terminal 300 does not have an email address listed in the database 308 of the messaging gateway server 304; this may be because the recipient terminal 300 is not capable of receiving email messages, or because the user of the recipient terminal 300 chooses not to subscribe to a service which involves listing his details in the database.

When the message is ready for sending, the user of the sending terminal 100a selects a telephone number of the recipient terminal 300; the messaging application 204 of the sending terminal 100a then sends the message to the messaging gateway server 304 using an email address of the messaging gateway server 304. When the message arrives at the messaging gateway server 304, the latter determines that the telephone number used for sending the message is not one for which a corresponding email address is listed in the database 308 of the server 304. It is therefore not possible for the message to be sent as an email to the recipient terminal 300. Instead, the messaging gateway server 304 contacts an SMS server 306, causing the latter to send an SMS message to the recipient terminal 300. The SMS message typically comprises some or all of the content of the email sent from the sending terminal 100a.

The above described three cases provide a description of examples of sending messages according to the present invention. We now turn to consider functions of the components of the systems described.

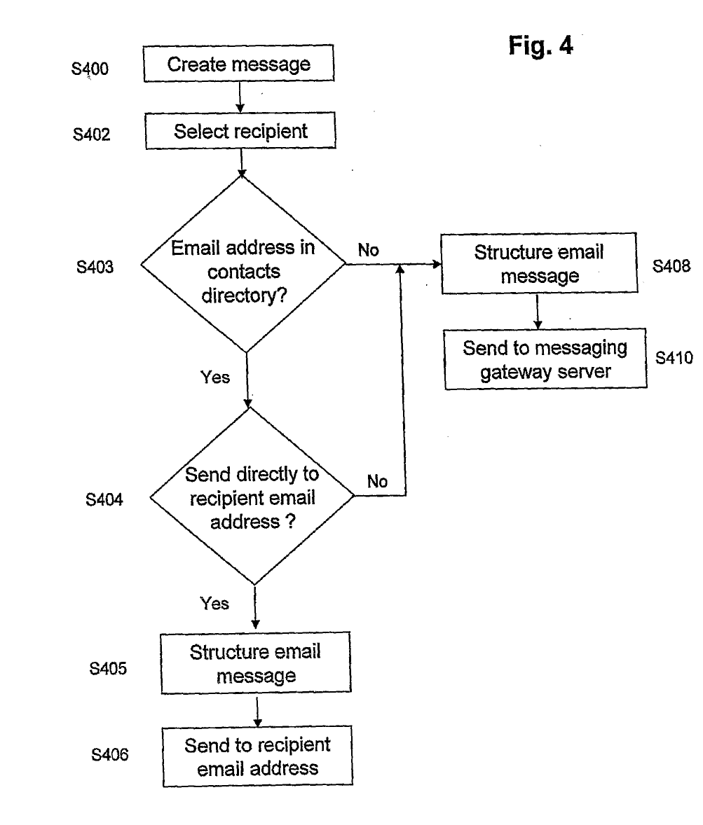

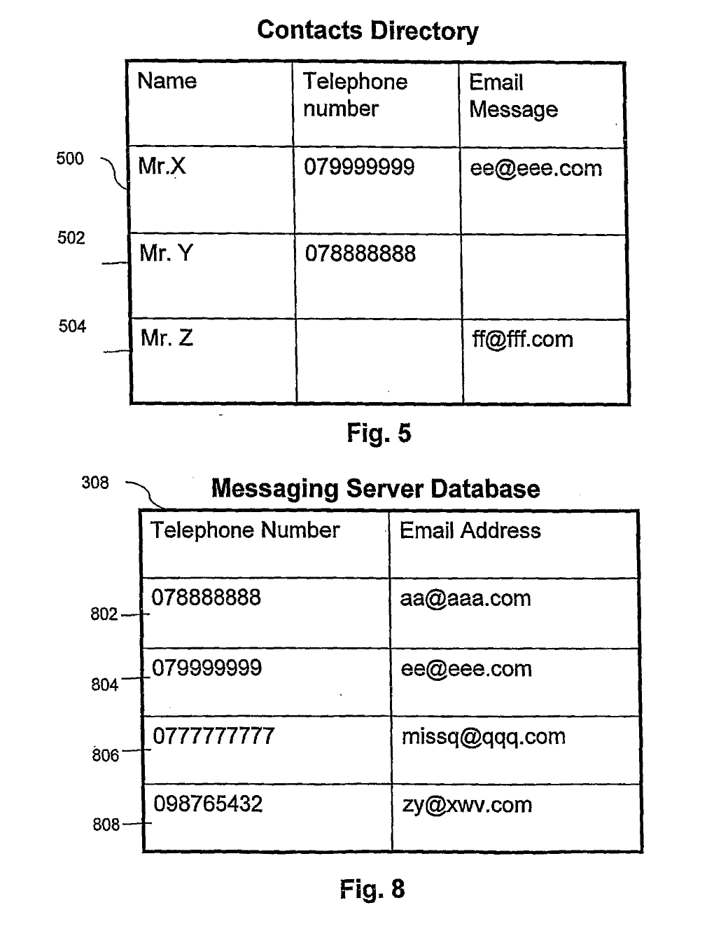

FIG. 4 is a flow diagram showing functions of a messaging application 204 used for sending messages from a sending terminal 100a, as described in the three above cases. At step S400, a message is created. At step S402 a message recipient is selected, which typically comprises selecting a name from a list of names, but may comprise, for example, directly selecting or inputting a telephone number or email address of the recipient. At step S403, the messaging application 204 determines whether the email address of the recipient is listed in a contacts directory; an example of such a contacts directory is represented in FIG. 5. In this example, which shows three entries, 500, 502 and 504, each entry has a data field available for each of a name, a telephone number and an email address. In particular, entries in the telephone number field are associated with entries in the email address field. It is not necessary that all fields are filled for each entry. Further, in some cases, the telephone number and the email address for each entry may be accessible and viewable by the user; in other cases, one or both of these may be neither accessible nor viewable by the user. In some arrangements, telephony terminals may contain a user-accessible contacts directory in addition to the contacts directory described herein. Returning to FIG. 4, if it is determined that the email address is not in the contacts directory, the email message is sent to a messaging gateway server 304 at step S410 as described in case 2 and case 3 above. However, before the message is sent, the messaging application 204 may structure the message at step S408 so that it is in a form convenient for processing at the messaging gateway server 304; in particular the message is arranged so that it includes information indicating a telephone number of the recipient of the message.

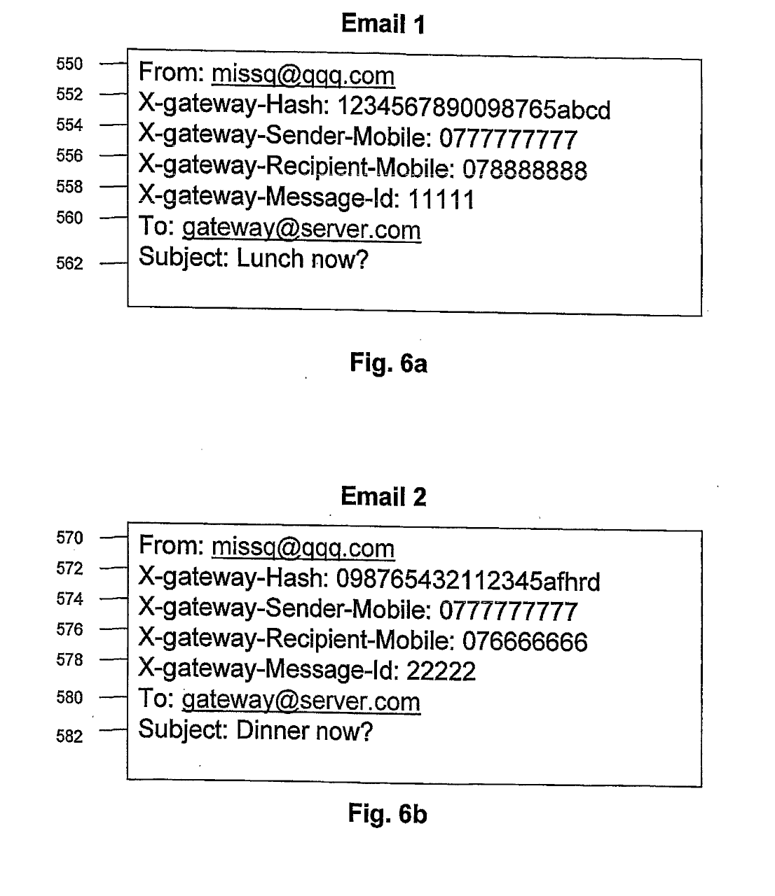

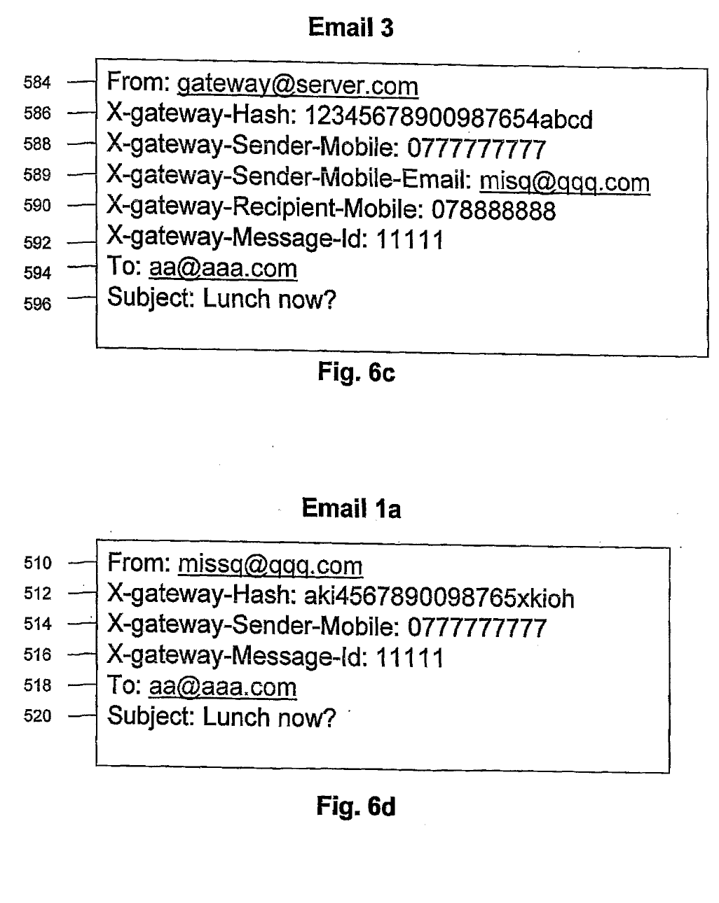

One way for the message to be structured is for it to be given special headers, an example of which is shown in FIG. 6a. In this example, the message is to be sent to Mr. Y, who is listed in the contacts directory of FIG. 5 at entry 502. The message headers include headers indicating the email address of the sender 550, and the subject of the message 562. The destination email address 560 is that of the messaging gateway server to which the message is being sent. A number of headers of the form “X- . . . ” are included (headers 552 . . . 558); these are “user defined fields” as provided for in the standard RFC 822 email specification and will be ignored by email transport mechanisms. A header indicating a telephone number of the sender 554 and a header indicating a telephone number of the recipient 556 are provided; the former is used for directory updating as described below, and the latter for determining an email address of the recipient at the server, as is also described below.

It may be convenient to provide headers indicating other information such as a message identification number 560 and/or a hash number 552, which could be determined by using a standard cryptographic “one way hash function” or “signature function” along with information from e.g. the senders email address, the sender's mobile number along with a secret identification number. The function of the X-gateway-Hash header 552 and the X-gateway-Message-ID header 558 will be described below. Typically, the “X- . . . ” headers 552 . . . 558 are added automatically by the messaging application 204 without any user input. It should be noted that usage of terms of the form “X-gateway . . . ” does not necessarily indicate that the corresponding header is created by a messaging gateway server 304; in some cases, the header is generated by a messaging application 204, for example.

Returning to step S403, if it is determined that an email address of the recipient selected is in the contacts directory, it is possible to send the message directly to the recipient email address. At step S404 it is determined whether to send the message directly to the recipient email address, or instead to send via the messaging gateway server 304; it may be convenient to send via the messaging gateway server 304 in order to take advantage of features of the present invention, including those described below. This determination may be made, for example, by the user in response to a prompt or the determination may be made by the messaging application 204 without any user input. If it is determined that the message is to be sent via the messaging server, the email message is structured at step S408 and sent at step S410 as described above.

If, at step S404, it is determined that the message is to be sent directly to the recipient email address, the email is structured by the messaging application 204 at step S405 into a form suitable for sending to the recipient's email address, and then sent at step S406; this corresponds to case 1 described above. FIG. 6d provides an example of email headers that may be used in structuring the email for sending to the recipient email address. In this case, it is not necessary to include a recipient telephone number because a recipient email address is already known.

In the above example given with reference to FIG. 4, at least a recipient telephone number was available to the sender. In other cases, embodiments of the present invention may be used to send messages where only an email address of the recipient is available to the sender.

Functions of a messaging gateway server 304 are now described with reference to FIG. 7. The server has access to database 308, shown in FIG. 8. The database 308 comprises a list of entries 802 . . . 808, each entry comprising a list of telephone numbers mapped with corresponding email addresses. When users subscribe to a messaging service, it is common for each user to provide details such as their mobile telephone number and email address; the database 308 may be composed from information provided by users in this way.

The server receives an email message at step S600. We first consider the case of the received email being of form of Email 1 shown in FIG. 6a, having been sent from sending terminal 100a, as described above. Email 1 includes information indicating a recipient telephone number 556 which is listed in database 308; this corresponds to case 2 described above. On receipt of the message, the server may perform a validity check with respect to the message. This may involve checking that the hash value in 552 is valid, or that the sender telephone number is listed in the database 308; this may be useful for preventing unauthorised use of the server, and preventing SPAM email. If the message is not found to be a valid message, it is discarded at step S602.

If the message is found to be valid, a determination is made at step S603 as to whether the recipient telephone number indicated in the recipient mobile header 556 is listed in database 308. In this case, the number is listed at entry 802. The recipient email address is then found at step S604; in this case, it is aa@aaa.com. The server now has enough information to forward the email to the recipient email address. In order to do this, it is necessary to restructure the email. This is done by rearranging the email headers into the form shown in Email 3 of FIG. 6c. The “To” header 594 now indicates an email address of the recipient, with the “From” header 584 now indicating an email address of the server. Other headers 586 . . . 592 provide details such as a sender telephone number and a sender email address; the significance of these is discussed below.

Returning to step S603, we now consider the case of the recipient telephone number included in the email message received at step S600 not being listed in database 308; this corresponds to case 3 described above. Email headers of an email for which this is the case are shown in Email 2 of FIG. 6b. When the server looks up the recipient telephone number of recipient mobile header 576 in the database, it finds that it is not listed. This may indicate that the recipient is not a subscriber to a service. Since the recipient email address is not listed, it is not possible to send an email to this email address. However, embodiments of the present invention enable an SMS message to be sent to the recipient.

Since, as discussed above, sending an SMS message may involve greater expense than sending an email message, it may be necessary or convenient to only allow SMS messages to be sent where the user has sufficient usage allocation available. Each user may be assigned a specified number of SMS messages that may be sent over a specified period of time, or users may allocate funds for sending SMS messages. Thus, at step S608 the messaging gateway server determines whether there is sufficient usage allowance for the present message to be sent. If sufficient funds are not available, the message is not sent; the sender may be notified that there are insufficient funds available by means of, for example, an email message or SMS message at step S610. If sufficient usage allocation is available, the usage allocation is decremented at step S612. The message is then converted into message data at step S614 for sending to a 3^{rd} party SMS bulk server at step S616. The message data may, for example, be sent using HTTP to communicate with the bulk SMS server, and comprise information indicating a recipient telephone number as well as a telephone number of the sending terminal 100a; the latter may be used to indicate to the recipient the sender of the SMS message. The bulk SMS server user then sends an SMS via, for example, a mobile telephone network. Note that, since SMS messages are limited in length, it may not be possible to send the entirety of the original email content by SMS; in this case the text of the SMS message may include only part of the message. In some arrangements, the SMS message sent may contain as text the content of the subject header 582 of the email.

### Directory Updating

Preferred embodiments of the present invention provide a messaging application 204 which enables messages transmitted by methods as described above to be received, and on receipt to update a contacts directory of the receiving device with a messaging address of the sender of the message for subsequent sending using the messaging address. The process of updating a contacts directory is hereinafter referred to as “directory updating”.

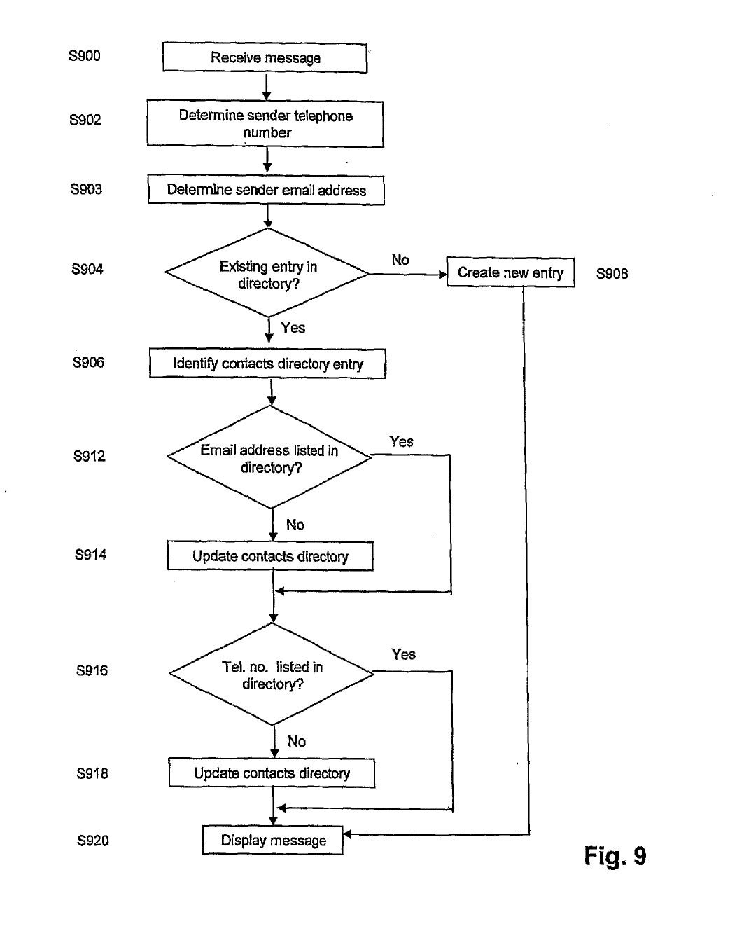

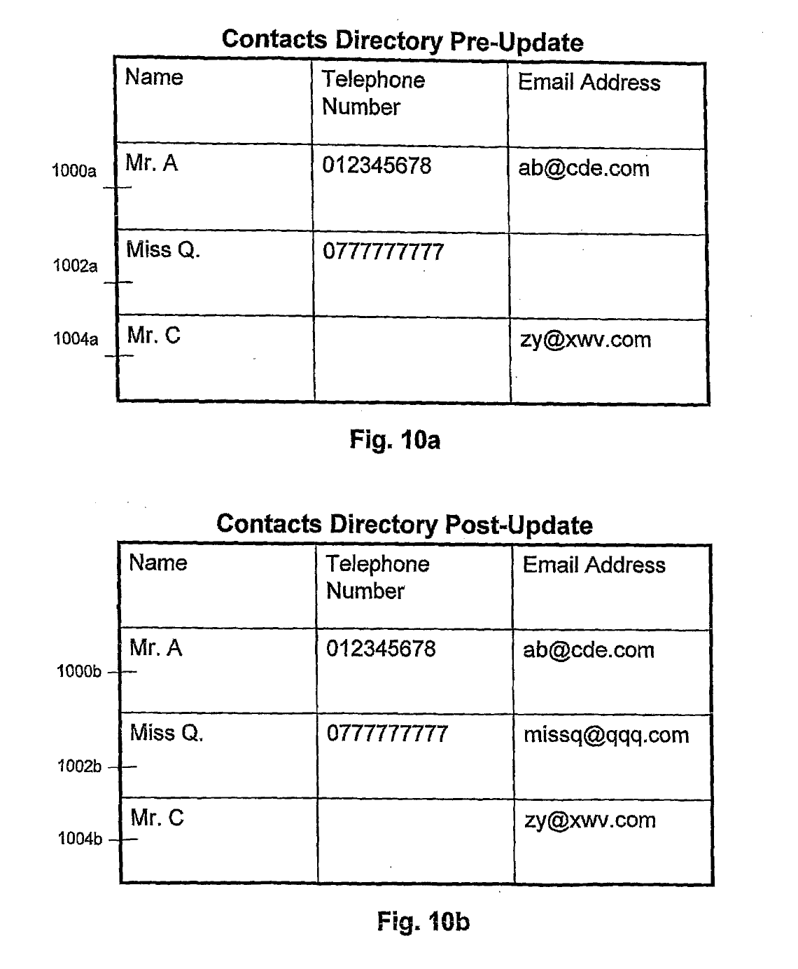

FIG. 9 shows a directory updating process. The steps of this process are typically performed by a messaging application 204. A message is received at a recipient terminal at step S900. The received message may be arranged in the form of Email 3 shown in FIG. 6c, containing header fields that indicate, inter alia, the email address of the sender of the message (header field 589). At step S902, the messaging application determines a telephone number of the sender. In the example of Email 3, this can be done simply by reading the sender mobile header 588. At step S903, the messaging application determines an email address of the sender; this can be done by reading the sender email header 589. At step S904, the sender email address and/or sender telephone number determined in the preceding steps are used to determine whether there is an existing entry corresponding to the message sender in a contacts directory. As an example, we consider the contacts directory represented in FIG. 10a. The sender telephone number indicated in sender mobile header 589 of Email 3 is listed in the contacts directory; the determination in this example is therefore that there is an existing entry. At step S906, the contacts directory entry corresponding to the telephone number is identified. In this case, the contacts directory entry is entry 1002a.

At step S912, if the email address determined at step S903 above is not listed in the contacts directory, the contacts directory is updated to include this email address at step S914. In the present case, directory entry 1002a contains no email address, so the directory is updated at step S914. The updating step may be done by the messaging application without any user input, or it may involve some user input, for example a prompt to update the entry. After step S914 has been performed the contacts directory in our example is as shown in FIG. 10b with all entries identical to the corresponding entry of FIG. 10a except that entry 1002b contains an email address in the email address field.

If the sender email address determined at step S903 is listed in the contacts directory, the messaging application 204 proceeds directly to step S916, which is described below.

At step S916, if the sender telephone number determined at step S902 above is not listed in the contacts directory, the contacts directory is updated to include this telephone number at step S918. The message is then displayed to the user at step S920. If the sender telephone number is listed, step S918 is not performed and the messaging application 204 proceeds directly to displaying the message at step S920. In the example of Email 3, the contacts directory contains the telephone number indicated in the sender mobile header 588, so step S918 is not performed.

Once the contacts directory has been updated with the sender email address and/or the sender telephone number has been cached, the messaging application can be used to send emails using the address and/or telephone number. Methods of selecting and sending using an email address and/or telephone number are described above with reference to FIG. 4.

Returning to step S904, if there is no entry in the telephone directory to which the telephone number corresponds, a new entry may be created. Any sender telephone number determined at step S902 and/or sender email address determined at step S904 may be included in the entry. These steps may be done automatically by the messaging application without any user input, or they may involve some user input, such as responding to a prompt to create the entry or inputting a name for the entry.

FIG. 9 and the above accompanying description provide one method of performing directory updating in accordance with embodiments of the present invention. Variations are envisaged. In particular, the sequence of the steps described may be varied; for example, in some embodiments it may convenient to perform step S912, checking whether the email address is listed in the contacts directory, prior to step S902, determining the telephone number of the sender.

It should be noted, that although in the example given the received email was email 3, which was sent from a messaging gateway server, the same method of directory updating can be applied to emails received from other sending devices, such as mobile telephones.

### Fallback Messaging

Embodiments of the present invention provide a mechanism for delivering a message using a second messaging protocol when delivery by a first messaging protocol is not completed. This is referred to as “fallback messaging” in the following discussion. In the following discussion, the first messaging protocol is suitable for email and the second suitable for SMS, but it will be apparent that other combinations of messaging protocols may be used.

Fallback messaging can be implemented in accordance with embodiments of the present invention using a system as shown in FIG. 3. As an example, we consider an initial email sent from a sending terminal 100a to a recipient terminal 100b. The initial email can be sent via ISP email providers 302a and 302b using normal email infrastructure, as described in Case 1 above. The email is arranged to prompt the messaging application 204 of the recipient terminal 100b to send a receipt acknowledgement to the sending terminal 100a upon receipt of the message. If the sending terminal 100a receives a receipt acknowledgement, the user of the sending terminal 100a can be informed by the messaging application 204 that the message has been delivered, and no further action is required. However, if no receipt acknowledgement is received, a second message may be sent from the sending terminal 100a to a messaging gateway server 304; the messaging gateway server 304 then contacts an SMS server 306, causing an SMS message to be sent to recipient terminal 100b.

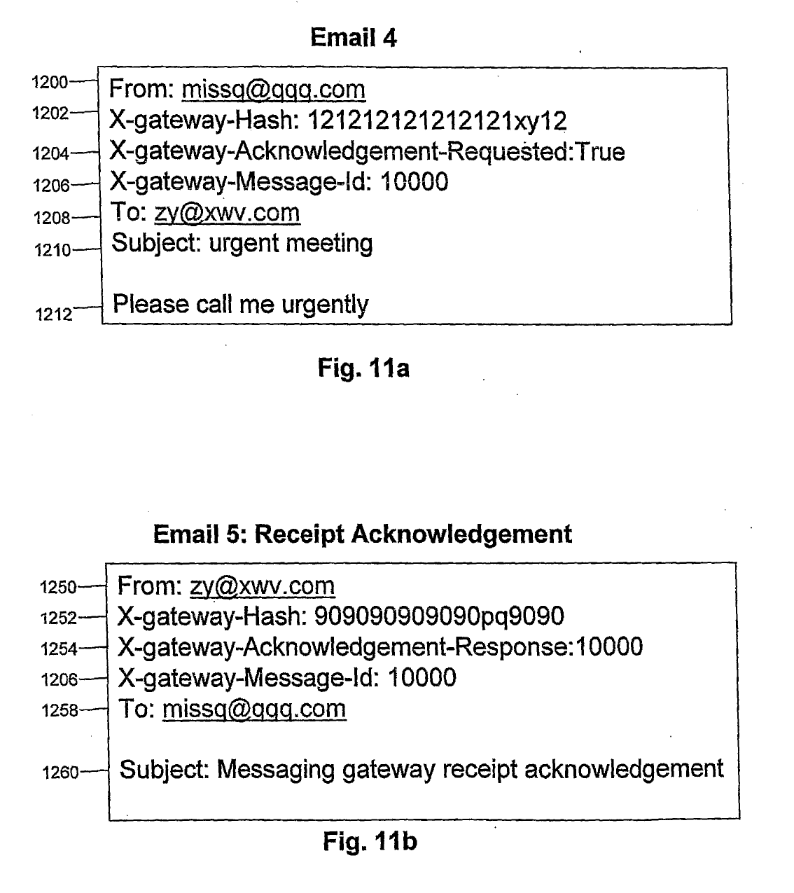

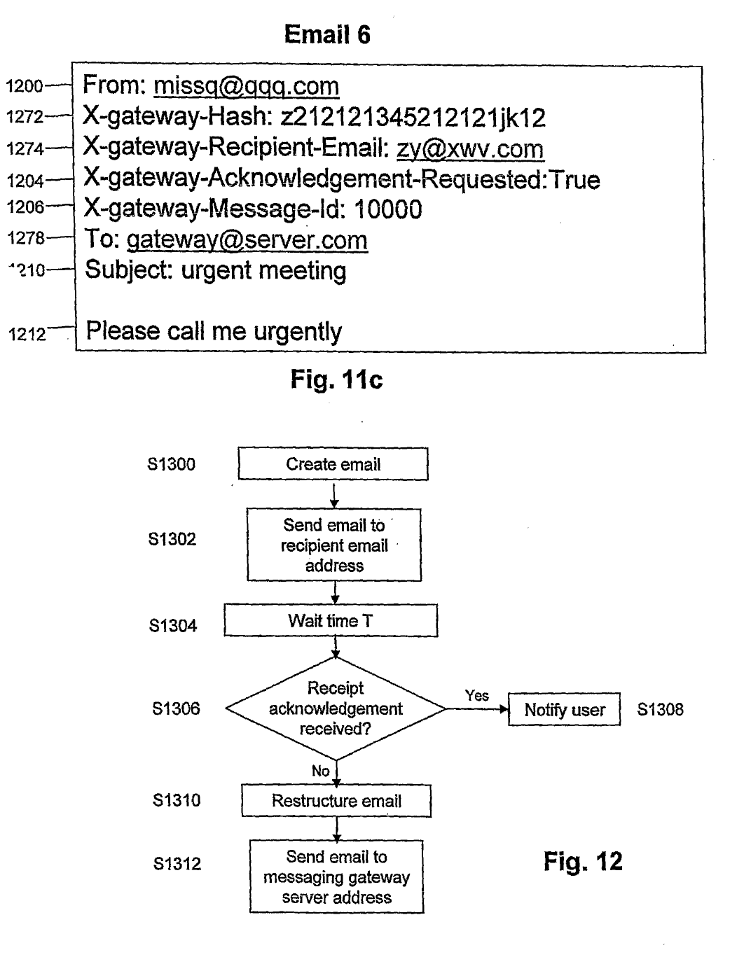

The initial email may be of the form shown of Email 4 shown in FIG. 11a. The initial email contains headers 1200 . . . 1210 and a message text 1212. The “from” header 1200 indicates an email address associated with sending terminal 1100a and the “to” header 1208 indicates an email address associated with terminal 1100b. Since an email address of the recipient terminal is used, in this case the email is not sent via a messaging gateway server 304; however, the discussion below applies to emails that have been sent via a messaging gateway server 304, as described above.

Email 4 also contains “X- . . . ” header fields; 1202 indicates a hash value, and 1206 indicates a message identification number. There may also be further headers not shown here, such as those described above indicating a sender telephone number etc. Acknowledgement-Requested header 1204 is a special extension header that prompts the messaging application of the recipient terminal to send a receipt acknowledgement, either with or without user input. This special extension header is similar to the “Disposition-Notification-To” header that is allowed by the “read receipt” mechanism specified in RFC 2298: “An Extensible Message Format for Message Disposition Notifications”.

If the messaging application of terminal 100b is activated and checking for email, it will receive Email 4 and present it to the user of terminal 1100b. Header 1204 causes the messaging application to send a receipt acknowledgement; this may be done without any user input, or it may involve the user responding to a prompt to send a receipt acknowledgement.

The receipt acknowledgement may be in the form of an email. Email 5 shown in FIG. 11b, is an example of such an email. This receipt acknowledgement is similar to the “Message Disposition Notifications” specified in RFC 2298. Email 5 is transmitted to sending terminal 100a. Acknowledgement-Response header 1254 indicates that the email is a receipt acknowledgement, and provides the message identification number of the message in response to which the receipt acknowledgement is being sent. In this case the message identification number is 10000, the identification number corresponding to Email 4. Sending terminal 100a can thus determine that Email 5 is a receipt acknowledgement corresponding to Email 4. In some cases, the messaging application provides an indication to the user that the email message sent has been delivered; in other arrangements, this may not be necessary. Since the receipt of Email 4 at terminal 100b has been acknowledged, there is no need to take any further action, such as sending a fallback message by an alternative route. The decision not to send is typically made by the messaging application without any input from the user.

However, if the messaging application of terminal 100b is not checking for email (this may be because, for example, the terminal itself is turned off, or because the messaging application is not active), Email 4 is not received by recipient terminal 100b, and no receipt acknowledgement is sent. In this case, the messaging application of sending terminal 100a sends an email to the messaging gateway server 304; the messaging gateway server 304 then contacts the SMS server 306, causing it to send an SMS message to terminal 100b. The operation of the SMS server 306 in doing this is described below.

The email sent from sending terminal 100a to the messaging gateway server may be of the form of Email 6, shown in FIG. 11c. Email 6 contains headers indicating, inter alia, the recipient email address (header 1274), and a message identification number (header 1206). This email is received and analysed by message gateway server 304, as is described in detail below.

FIG. 12 shows steps performed by messaging application 204 of sending terminal 100a in implementing fallback messaging in accordance with embodiments of the present invention. At step S1300, an email is created; this may be an email of the form of Email 4 shown in FIG. 11a, and described above. The email is typically created in response to user input of, inter alia, the text of the message 1212 and selection of a recipient from a list of recipients of a contacts directory.

At step S1302, the email is sent to the recipient email address, shown in “To” header 1208. After sending the email, the messaging application 204 of sending terminal 100a monitors for a receipt acknowledgement of the form described above in relation to FIG. 11b. This may involve waiting a predetermined length of time, T. In some arrangements, the length of this period may be fixed and not vary from message to message. In other arrangements, it may vary according to an urgency level of the email; the urgency level may be selectable by the user of the sending terminal at the point of sending.

After waiting time T, the messaging application determines whether a receipt acknowledgement has been received at step S1306. If a receipt has been received, no further action is required; in some arrangements the messaging application may display a message to the user indicating that the email has been delivered at step S1308.

However, if after time T the receipt acknowledgement has not been received, the email is restructured into a form suitable for sending to a messaging gateway server 304; this restructuring typically involves arranging the email headers into a form shown in Email 6 of FIG. 11c, including inserting the recipient terminal email address into a recipient email header 1274, inserting a hash value into gateway hash header 1272, inserting a message identification number into a gateway-message-ID header 1206, and inserting the messaging gateway server 304 email address into the “To” header 1278. The message is then sent to the messaging gateway server address at step S1312.

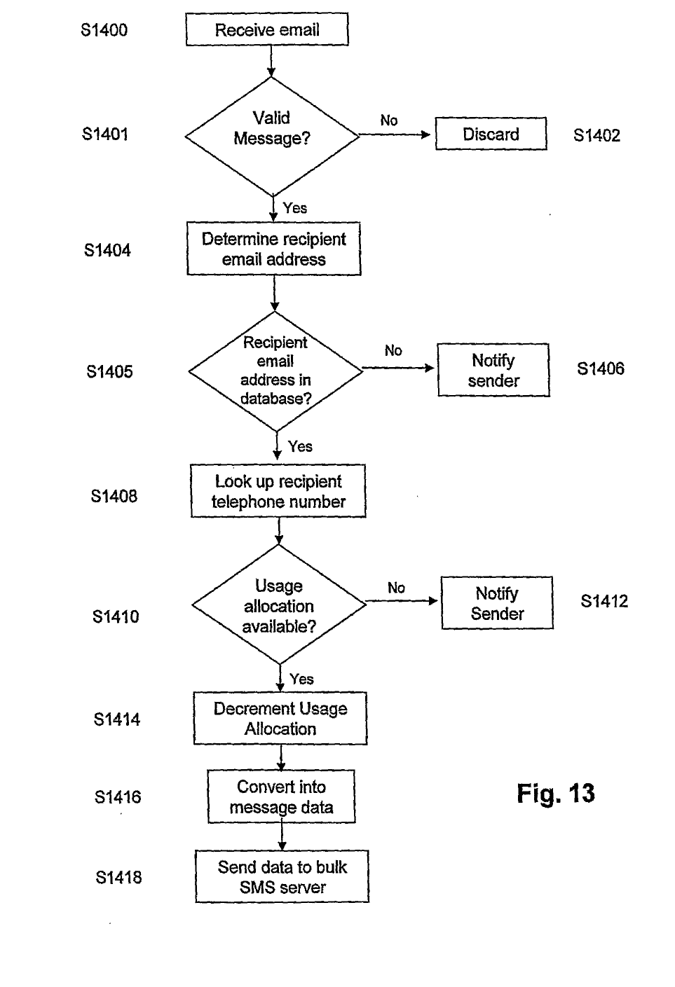

Turning to FIG. 13, steps performed by the messaging gateway server 304 in performing fallback messaging in accordance with embodiments of the present invention are now described. At step S1400, the server receives an email of the form of Email 6, shown in FIG. 11c, and described above. The server may use the hash value of gateway-hash header 1272, for example, to verify the email, as described above, at step S1401. If the email is found not to be valid, it is discarded at step S1402. If, however, it is found to be valid, the email address of the recipient is determined at step S1404; this can be done by reading the email address from header 1274. At step S1405, the messaging gateway server 304 uses the database 308 to determine whether the recipient email address is in the database. If it is not, since no telephone number for the recipient is available, it is not possible to send an SMS message to the recipient; the sender may be notified that fallback messaging is not available at step S1406 by means of, for example, an email message or SMS message.

However, if, as in the example of Email 6, the email address is listed in the database, a telephone number corresponding to the email address is found in the database at step S1408; in the present example the telephone number is that listed in entry 808.

At step S1410, the server determines whether there is sufficient remaining usage allocation for that user to send an SMS. If sufficient funds are not available, the message is not sent; the sender may be notified that there is insufficient user allocation available by means of, for example, an email message or SMS message at step S1412. If there is sufficient allocation available, the usage allocation is decremented at step S1414. At step S1416, the email is converted into message data for sending to a bulk SMS server. The data is sent to the bulk SMS server at step S1418.

An SMS message is then sent from the bulk SMS server to the recipient terminal 100b. The SMS message may comprise part or all of the email message originally sent from terminal 100a. However, in other arrangements the SMS may alternatively or additionally contain a command that causes the messaging application 204 of recipient terminal 100b to activate and collect the email message. This may be done by registering the messaging application 204 to start running, or to be notified if it is already running on receipt of an SMS of a certain form. For example, with the Java J2ME programming language, it is possible to register a Java client application (called a “MIDlet”) to wake up and be notified when an SMS with a certain port number is specified in the message.

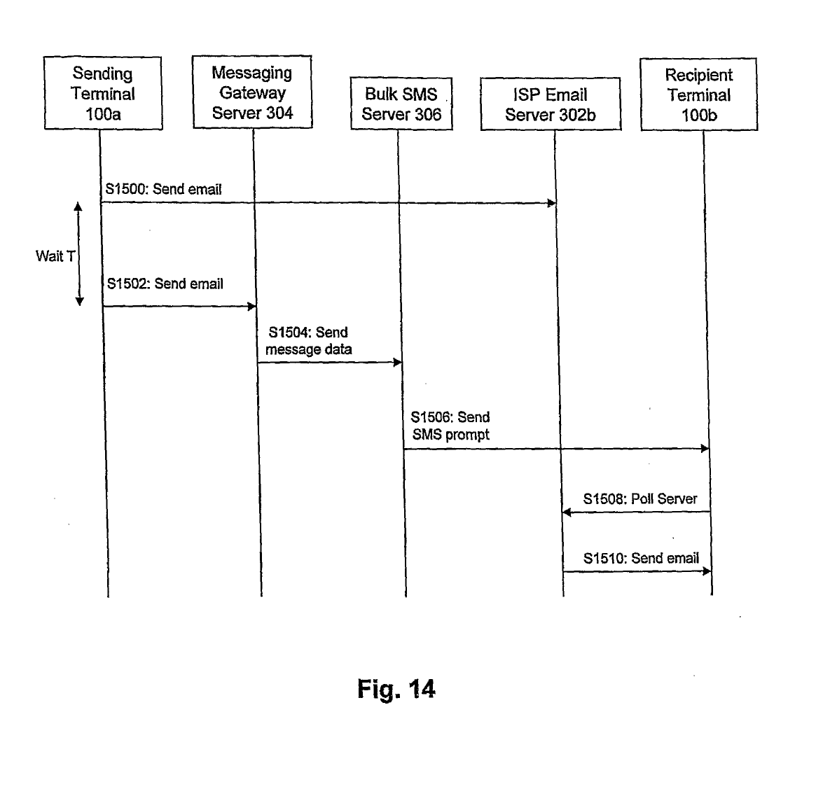

An example of an SMS being used to prompt a messaging application to collect an email message is now given with reference to FIG. 14. In this example, a message is sent from terminal 100a to terminal 100b. An email is sent from terminal 100a to an ISP email server 302b; the email is stored at an inbox of the ISP email server 302b corresponding to an email address associated with terminal 100b. After sending the email, the messaging application 204 of the sending terminal 100a monitors for a receipt acknowledgement for time T. In this example, the recipient terminal 100b does not retrieve the email message from the server before time T has elapsed, and no receipt acknowledgement is sent; at step S1502 an email is therefore sent from terminal 100a to the messaging gateway server 304. In response to this, the messaging gateway server 304 sends message data to bulk SMS server 306 at step S1504. SMS server 306 uses this data to send an SMS prompt to terminal 1100b via, for example, a mobile telecommunications network. This causes the messaging application 204 of the recipient terminal 100b to activate (if it is not already activated) and poll the ISP email server 302b at step S1508 in order to retrieve the email message. The ISP email server 302b sends the email to the recipient terminal 100b at step S1510.

The above embodiments are to be understood as illustrative examples of the invention. Further embodiments of the invention are envisaged. For example, the above discussion has referred to email and SMS messaging, but other types of messaging may be used in embodiments of the invention. Further, the discussion has referred to telephone numbers, but other types of telephony identifiers, such as SIP identifiers could be used. The above discussion has also referred to ISP email servers, but other types of email servers could be used.

Also, in the discussion of fallback messaging, the email is sent via a messaging gateway server; in other arrangements, the email may not be sent via a messaging gateway server, and may comprise headers different from those of the examples give. Furthermore, in the example given, the email received by the server contained no recipient telephone number; however, in some cases, the email received may contain a recipient telephone number, and this number is used to send an SMS message to the recipient.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-43. (canceled)

44. A method of messaging in a data communications network using a messaging application stored on a telephony terminal, said method comprising the steps of:
receiving a message using said messaging application, said received message comprising data indicating a telephony identifier of the sender of the message and further comprising data indicating a messaging address of the sender, said messaging address being different to said telephony identifier;
using the data indicating a telephony identifier to identify an entry of a contacts directory of said telephony terminal;
creating an association between said messaging address and said telephony identifier;
and transmitting a message using said messaging application, said transmitted message including said messaging address as a destination address.

45. A method according to claim 44 wherein said transmitted message includes said messaging address as a destination address in response to a user selection of said entry of the contacts directory.

46. A method according to claim 44, in which said messaging address is not held in said contacts directory before the received message is received.

47. A method according to claim 44 in which said association is created without any user input.

48. A method according to claim 44 in which the received message is received via a server, an originating address of the received message having been inserted by the server.

49. A method according to claim 48, in which said inserted originating address comprises an address of said server.

50. A method according to claim 44 in which an originating address of the received message has been inserted by the sender.

51. A method according to claim 50, in which said inserted originating address comprises an address of the sender.

52. A method according to claim 44, in which said user selection of said entry comprises entry or selection of said telephony identifier by the user.

53. A method according to claim 44, in which said messaging address comprises an email address and said transmitted message comprises an email.

54. A method according to claim 44, in which the received message comprises an email.

55. A method of transmitting messages, originated from a first telephony terminal, via a data communications network, said network comprising a server, said server comprising a database of telephony identifiers of telephony terminals and addresses, each address being associated with a corresponding telephony identifier, said method comprising:
transmitting a first message to a second telephony terminal, wherein transmitting said first message comprises:
selecting a telephony identifier of the second telephony terminal;
determining whether said telephony identifier of the second telephony terminal is listed in said database; and
in response to determining that said telephony identifier of the second telephony terminal is listed in said database, using said database and said telephony identifier of the second telephony terminal to determine an associated address, and sending said first message to said associated address,
said method further comprising transmitting a second message to a third telephony terminal, wherein transmitting said second message comprises:
selecting a telephony identifier of the third telephony terminal;
determining whether said telephony identifier of the third telephony terminal is listed in said database; and
in response to determining that said telephony identifier of the third telephony terminal is not listed in said database, addressing said second message using said telephony identifier of said third telephony terminal, and sending said second message.

56. A method according to claim 55, wherein sending said first message and/or said second message comprises sending from said server.

57. A method according to claim 55, wherein sending said first message and/or said second message comprises sending from said first telephony terminal.

58. A method according to claim 55 wherein said method comprises receiving a message from said first communications terminal at said server.

59. A method according to claim 58, wherein said received message is addressed to an email address of said server and received via email.

60. A method according to claim 58 wherein the received message does not include an associated email address.

61. A method according to claim 55 wherein the message sent to the third telephony terminal comprises an SMS message.

62. A method of transmitting a first message in a data communications network, the message having as an originating point a first user terminal and having as a destination point a second user terminal, at least the second user terminal being a mobile communications terminal capable of receiving service in a mobile communications network, and at least the second user terminal being capable of receiving messages using a first messaging protocol and messages using a second messaging protocol, said method comprising:
sending said first message using a first messaging protocol;
monitoring for an acknowledgement of receipt of said message; and
in the case that no said acknowledgement is received, causing a second message to be sent using a second messaging protocol.

63. A method according to claim 62 in which said data communications network comprises a server, said server causing said second message to be sent.

64. A method according to claim 63, in which said method comprises conducting said monitoring at said server.

65. A method according to claim 62, in which said method comprises conducting said monitoring at said first communications terminal and in which said causing comprises sending a third message from said first communications terminal to said server.

66. A method according to claim 65, in which said third message is sent using said first messaging protocol.

67. A method according to claim 62 in which said first messaging protocol is suitable for transmitting emails and said first message comprises an email message.

68. A method according to claim 62 wherein the acknowledgement being monitored comprises an email message.

69. A method according to claim 62 in which said second messaging protocol is suitable for transmitting SMS messages and said second message comprises an SMS message.

70. A method according to claim 69, in which said causing comprises causing second message to be sent from an SMS bulk server.

71. A method according to any of claim 62 in which said second message comprises at least part of said first message.

72. A method according to any of claim 62 in which said second message comprises a command to start up a messaging application.

73. A method according to claim 72, further comprising, in response to receiving said command, starting up said messaging application and using said messaging application to retrieve said first message.

74. A method according to any of claim 62 in which said monitoring comprises monitoring for the elapsing of a predetermined time interval and the causing of the sending of the second message is done in response to said elapsing.

75. A method according to claim 74, in which the length of said predetermined time interval is determined by a parameter of the first message.

76. A method according to claim 75, in which said parameter is capable of being varied by a user.

77. Apparatus arranged to implement the method steps of claim 44, 55 or 62.

78. A telephony terminal adapted to perform the method steps of claim 44.

79. A computer program arranged to adapt a telephony terminal to perform the method steps of any of claim 44, 55 or 62.

80. A telephony terminal adapted to perform the method steps of claim 55.

81. A computer program arranged to adapt a telephony terminal to perform the method steps of claim 55.

82. A server adapted to perform the method of claim 62.

83. A computer program arranged to adapt a server to perform the method of claim 62.

84. A method of messaging using a data communications network including a plurality of user controlled message transmitting and receiving devices, said network including a server used to control the transmission of said messages in differing formats, said network also including a database on which are stored identifiers, each identifier relating to a specific transmitting and receiving device, and a messaging address of the message sender and upon receipt of a message from a specific device which includes an identifier and a messaging address, an association between the same is established and wherein thereafter a message can be sent to the specific device using the identifier and/or messaging address, and the format in which the message is sent is dependent upon whether the identifier or messaging address is used and/or other information associated therewith.

85. A method according to claim 84 wherein the message is transmitted in a first format and, if not received successfully is resent in a second format.

86. A method according to claim 85 wherein the message is transmitted in a first format using the messaging address and in a second format using the identifier which is a telephony identifier.
